(19) United States
(12) Patent Application Publication
(10) Pub. No.: US 2013/0005352 A1
(43) Pub. Date: Jan. 3, 2013

(54) LOCATION VERIFICATION FOR MOBILE DEVICES

(75) Inventors: Ryan D. Jones, Mundelein, IL (US); Jason Jae Hyun Koh, Vernon Hills, IL (US); James A. Rumpler, Chicago, IL (US)

(73) Assignee: MOTOROLA MOBILITY, INC., Libertyville, IL (US)

(21) Appl. No.: 13/173,540

(22) Filed: Jun. 30, 2011

(51) Int. Cl. H04W 24/00

(52) U.S. Cl. 455/456.1

(57) ABSTRACT

Methods are provided for verifying whether a mobile device is at a site. An exemplary method involves obtaining a location of the mobile device from the mobile device and obtaining a captured value for a machine-readable code from one of the mobile device and the site, the machine-readable code being presented by the other of the mobile device and the site. When the captured value is equal to a reference value for the code, the mobile device is verified as being at the site when the location of the mobile device corresponds to a location associated with the site.

### TECHNICAL FIELD

Embodiments of the subject matter described herein relate generally to mobile devices, and more particularly, embodiments of the subject matter relate to using a machine-readable code to verify a mobile device's location.

### BACKGROUND

In recent years, social networking services have been increasing in popularity. Some social networking services allow individuals to use their mobile devices to “check-in” at various locations of interest, such as businesses, restaurants, bars, clubs, concerts, theaters or other entertainment venues, sporting events, and other points of interest. Additionally, some social networking services may reward users for checking-in at various locations, for example, to promote usage of the check-in service or to advertise locations whose operators have partnered with the social networking service. Accordingly, it is desirable to verify that an individual is physically at the location he or she is attempting to check-in at to protect against individuals who may attempt to fraudulently check-in (e.g., a “drive-by” check-in, location spoofing, or the like) to obtain rewards or otherwise misuse the check-in service.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram of an exemplary electronic device in accordance with one embodiment;

FIG. 2 is a block diagram of an exemplary check-in system in accordance with one embodiment;

FIG. 3 is a flow diagram of a check-in process suitable for use with the check-in system of FIG. 2 in accordance with one or more embodiments; and

FIG. 4 is a block diagram of another exemplary embodiment of a check-in system capable of implementing the check-in process of FIG. 3.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration,” and any implementation described herein as exemplary is not necessarily to be construed as preferred or advantageous over other implementations. Furthermore, there is no intention to be bound by any expressed or implied theory presented in the preceding technical field, background, or the following detailed description.

Embodiments of the subject matter described herein relate to verifying the location of a mobile device as being at a site that the user of the mobile device is attempting to “check-in” at. As used herein, “checking-in” and variants thereof should be understood as referring to the process of a user of a mobile device registering his or her physical location as being at a particular site using a social networking service. In this regard, a site is a physically distinct region associated with or otherwise corresponding to a business or another entity that a user is capable of “checking-in” at using a social networking service, such as, for example, a place of business or a point of interest.

As described in greater detail below, in accordance with one or more exemplary embodiments, the site is capable of presenting a machine-readable code, such as a quick response (QR) code or another barcode, having an encoded value that varies dynamically over time, such that the encoded value is effectively randomized. The mobile device captures a value represented by the machine-readable code at a particular instant in time and transmits, to a check-in service application executing on a server, the captured value along with a location of the mobile device determined using the global positioning system (GPS), triangulation, or another suitable positioning method. In response to receiving the device location and the captured value for the code, the check-in service application obtains a reference value for the code that was displayed at the instant in time the captured value was captured by the mobile device, and after determining whether the captured value matches the reference value, the device location is compared to a known location for the site. When the device location corresponds to the site location, the mobile device's location is verified as being at the site, thereby allowing the user to successfully check-in to the site. In this manner, the captured value for the code functions as a primary indication of the mobile device's location, while the device's location obtained using another positioning method is used secondarily to confirm or otherwise authenticate that the mobile device is at the site.

In an alternative embodiment, the mobile device presents the machine-readable code, wherein the site is configured to capture the value represented by the code on the mobile device at a particular instant in time. In response to receiving the captured value for the code, the check-in service application obtains, from the mobile device, the device's location and determines a reference value for the code that was displayed at the instant in time the captured value was captured by the site. After determining whether the captured value matches the reference value, the device location is compared to a known location for the site, and the mobile device's location is verified as being at the site when the device location corresponds to the site location, as set forth above and described in greater detail below.

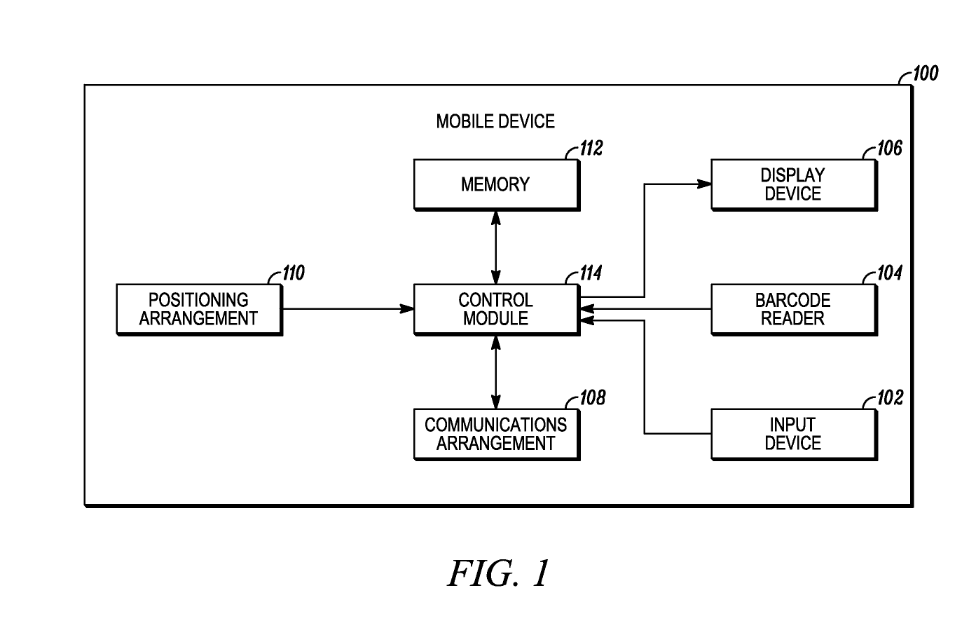

FIG. 1 depicts an exemplary embodiment of an electronic device 100, such as a mobile communications device (e.g., a cellular phone, tablet, personal digital assistant, laptop computer, netbook, or the like). In an exemplary embodiment, the mobile device 100 includes, without limitation, an input device 102, a barcode reader 104, a display device 106, a communications arrangement 108, a positioning arrangement 110, a memory 112, and a control module 114. It should be understood that FIG. 1 is a simplified representation of an electronic device for purposes of explanation and is not intended to limit the scope of the subject matter in any way.

In the illustrated embodiment, the input device 102 generally represents the hardware, software, firmware, or combinations thereof configured to provide a user interface with the mobile device 100. Depending on the embodiment, the input device 102 may be realized as a key pad, a keyboard, one or more buttons, a touch panel, a touchscreen, an audio input device (e.g., a microphone), or the like. The control module 114 is coupled to the input device 102 to receive input from the user of the mobile device 100 via the input device 102 and to facilitate operation of the mobile device 100 in accordance with the received user input. The barcode reader 104 is realized as a camera or other means for capturing and decoding machine-readable codes. The display device 106 is realized as an electronic display configured to graphically display information or content under control of the control module 114. Depending on the embodiment, the display device 106 may be realized as a liquid-crystal display, a light-emitting diode display, an organic light-emitting diode display, a plasma display, or another suitable electronic display. The control module 114 is coupled to the display device 106, and the control module 114 controls the display and rendering of content on the display device 106, as described in greater detail below. The communications arrangement 108 generally represents the hardware, software, firmware, or combinations thereof configured to transmit and receive incoming communications and signals directed to and from the mobile device 100 via one or more communications channels in a conventional manner. In this regard, in practice, the communications arrangement 108 may include one or more amplifiers, filters, modulators, or demodulators, digital-to-analog converters, analog-to-digital converters, mixers, antennas, and the like. The communications arrangement 108 is coupled to the control module 114, and the communications arrangement 108 and the control module 114 are cooperatively configured to support communications to and from the mobile device 100 in a conventional manner, as will be appreciated in the art.

In an exemplary embodiment, the positioning arrangement 110 represents the hardware, software, firmware, or combinations thereof configured to determine the current (or instantaneous) location of the mobile device 100. In this regard, the positioning arrangement 110 may include one or more receivers for obtaining the current location of the mobile device 100 using GPS. In other embodiments, the positioning arrangement 110 may include hardware, software, or processing logic configured to determine the current location of the mobile device 100 by performing triangulation using the location of wireless access points, cell phone towers, or the like, that the mobile device 100 is communicating with. Various methods for calculating or otherwise determining the current location of a mobile device 100 are well known, and accordingly, will not be described in detail herein.

Still referring to the exemplary embodiment of FIG. 1, the control module 114 generally represents the hardware, software, firmware, processing logic, or other components of the mobile device 100 configured to support operation of the mobile device 100 and to execute various functions and processing tasks described in greater detail below. Depending on the embodiment, the control module 114 may be implemented or realized with a general-purpose processor, a microprocessor, a controller, a microcontroller, a state machine, a content-addressable memory, an application-specific integrated circuit, a field-programmable gate array, any suitable programmable logic device, discrete gate or transistor logic, discrete hardware components, or any combination thereof, designed to perform the functions described herein. Furthermore, the steps of a method or algorithm described in connection with the embodiments disclosed herein may be embodied directly in hardware, in firmware, in a software module executed by control module 114, or in any practical combination thereof. The memory 112 represents any non-transitory short- or long-term storage media capable of storing programming instructions for execution by the control module 114, including any sort of random access memory, read only memory, flash memory, registers, hard disks, removable disks, magnetic or optical mass storage, and the like. The programming instructions, when read and executed by the control module 114, cause the control module 114 to execute a client check-in service application and perform certain tasks, operations, functions, and processes described in more detail herein.

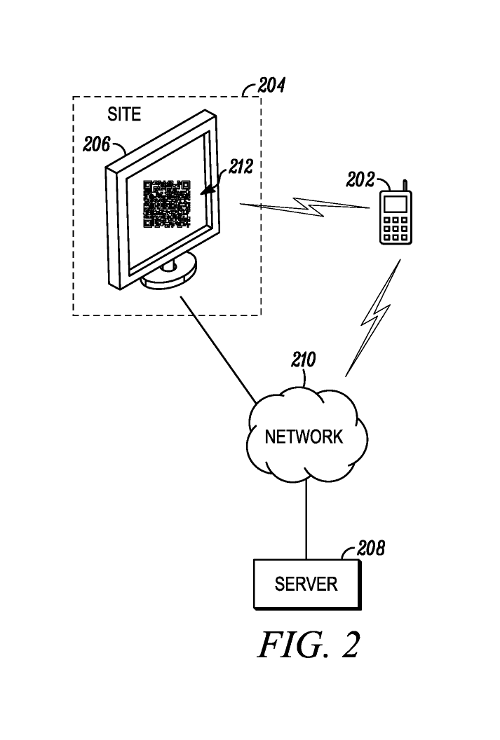

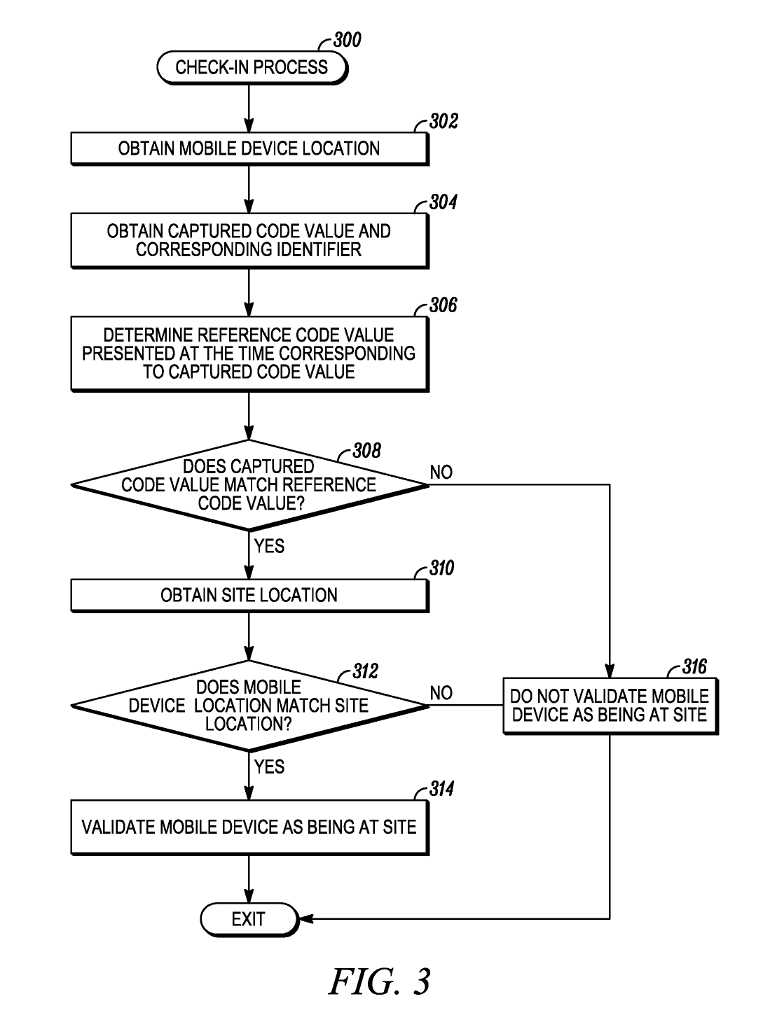

FIG. 2 depicts an exemplary check-in system 200 suitable for implementing the check-in process 300 described below in the context of FIG. 3 to verify that the location of a mobile device 202 is at a site 204. The check-in system 200 includes, without limitation, an electronic device 206 having a substantially fixed location at the site 204 and a check-in server 208. As illustrated, the electronic device 206 and the check-in server 208 are each coupled to a communications network 210 configured to support communications between the electronic device 206 and the server 208. It should be understood that FIG. 2 is a simplified representation of the check-in system 200 for purposes of explanation and is not intended to limit the scope of the subject matter in any way. In this regard, although the check-in system 200 is described in the context of a single site 204 for ease of explanation, it will be appreciated that in practice, the check-in system 200 is adaptable to support any number of sites.

In an exemplary embodiment, the site 204 generally represents a physically distinct region corresponding to a business or another entity that a user is capable of checking-in at using a host check-in service application provided by the server 208, such as, for example, a building (or a portion thereof), a venue, a place of business, or another facility or point of interest. In accordance with one embodiment, the site 204 has a fixed location that is stored or otherwise maintained by the server 208, as described in greater detail below. The electronic device 206 is located within the confines of the site 204 (i.e., at the site 204) and is configured to present or otherwise display a machine-readable code 212 that is representative of a site identifier and a variable code value, as described in greater detail below. For convenience, the electronic device 206 may alternatively be referred to herein as the site device. In an exemplary embodiment, the machine-readable code 212 is realized as a quick response (QR) code, however, in other embodiments, the machine-readable code 212 may be realized using another suitable barcode scheme. As described in greater detail below, the code value (or encoded value) represented by the code 212 varies dynamically, and accordingly, for convenience, the machine-readable code 212 presented by the site device 206 at the site 204 is alternatively referred to herein as a variable code. It should be appreciated that although the portions of the variable code 212 corresponding to the encoded value may vary over time, the portion of the variable code 212 corresponding to the site identifier may be fixed. In some embodiments, the site device 206 may be realized as a computer or another similar electronic device having an electronic display capable of displaying the variable code 212. In other embodiments, the site device 206 may be realized as a projector or another similar device configured to present the variable code 212 on an external display surface at the site 204, such as a projection screen, a wall, a sheet of paper, or the like.

In the illustrated embodiment, the site device 206 is communicatively coupled to the server 208 via the communications network 210, which generally represents the hardware, software, firmware, processing logic, or other infrastructure components configured to support communications between the server 208 and the electronic devices 202, 206. Depending on the embodiment, the communications network 210 may be realized as a cellular network or another suitable radio network, a computer network (e.g., a wide area network, a wireless local area network, or the like), or a combination thereof.

As described above in the context of FIG. 1, in an exemplary embodiment, the mobile device 202 includes a reader (e.g., barcode reader 104) capable of capturing, scanning, decoding, or otherwise obtaining the site identifier and the encoded value represented by the variable code 212 at an instant in time (alternatively referred to herein as the captured code value). Additionally, the mobile device 202 includes a positioning arrangement (e.g., positioning arrangement 110) configured to obtain the location of the mobile device 202. As described in greater detail below in the context of FIG. 3, when the user of the mobile device 202 attempts to check-in at the site 204, the client check-in service application executing on the mobile device 202 transmits or otherwise provides the site identifier and captured code value of the variable code 212 presented at the site 204 along with its location identified by the positioning arrangement to the server 208 via the network 210.

Still referring to FIG. 2, the server 208 generally represents a computing system or another combination of other hardware, software, firmware, processing logic, or other components that is coupled to the network 210 and is configured to support the check-in process 300 described in greater detail below in the context of FIG. 3. In an exemplary embodiment, the server 208 includes or otherwise accesses a memory or another non-transitory computer-readable medium of storing programming instructions for execution by the server 208, such as, for example, random access memory, read only memory, flash memory, registers, hard disks, removable disks, magnetic or optical mass storage, and the like. The computer-executable programming instructions, when read and executed by the server 208, cause the server 208 to execute a host check-in service application that communicates with the client check-in service application being executed by the mobile device 202 and that performs various tasks, operations, functions, and processes to support the check-in process 300, as described in greater detail below. Additionally, in some embodiments, the server 208 may also store or otherwise maintain (e.g., in memory) the fixed location of the site 204 in association with the site identifier corresponding to the site 204 along with the fixed location and site identifiers of additional sites within the check-in system 200.

In accordance with one or more embodiments, the host check-in application being executed by the server 208 is configured to control the displayed code value for the variable code 212 at the site 204. In this regard, the host check-in application on the server 208 may periodically command, signal, or otherwise instruct the site device 206 to vary the code value represented by the variable code 212. For example, the server 208 may signal the site device 206 to change the encoded value represented by the variable code 212 every twenty seconds. In exemplary embodiments, the server 208 periodically provides random values to be encoded and represented by the variable code 212. In other embodiments, the server 208 may cause the variable code 212 to progress through a sequence of values, wherein the value encoded and represented by the variable code 212 is changed at irregular intervals.

Turning now to FIG. 3, in an exemplary embodiment the check-in system 200 is configured to perform a check-in process 300 and additional tasks, functions, and operations as described below to verify or otherwise validate the location of the mobile device 202 as being at the site 204. The various tasks may be performed by software, hardware, firmware, or any combination thereof. For illustrative purposes, the following description may refer to elements mentioned above in connection with FIGS. 1 and 2. In practice, the tasks, functions, and operations may be performed by different elements of the described system, such as the barcode reader 104, the positioning arrangement 110, the control module 114, the mobile device 202, the site device 206, and the server 208. It should be appreciated that any number of additional or alternative tasks may be included and may be incorporated into a more comprehensive procedure or process having additional functionality not described in detail herein.

Referring to FIG. 3, and with continued reference to FIGS. 1 and 2, in an exemplary embodiment the check-in process 300 initializes or otherwise begins after a user has manipulated the mobile device 202 to attempt to check-in at the site 204. In this regard, the user of the mobile device 202 manipulates the input device 102 to cause the mobile device 202 to execute a client check-in service application that communicates with the host check-in service application being executed by the server 208 via the network 210. The user of the mobile device 202 then positions the mobile device 202 with respect to the variable code 212 presented at the site 204 and manipulates the input device 102 to capture, scan, decode, or otherwise obtain, via the barcode reader 104, the encoded value of the variable code 212 displayed at that particular instant in time along with the site identifier for the site 204 included in the variable code 212.

In an exemplary embodiment, the check-in process 300 continues with the host check-in service application receiving or otherwise obtaining from the mobile device 202 the location of the mobile device 202, the site identifier corresponding to the site the user is attempting to check-in at, and the captured code value for the variable code presented at the site the user is attempting to check-in at (tasks 302, 304). In this regard, the client check-in service application on the mobile device 202 obtains the most recently identified location of the mobile device 202 from the positioning arrangement 110 and transmits the mobile device's location to the host check-in service application on the server 208 along with the site identifier and captured code value. In an exemplary embodiment, the location of the mobile device 202 obtained from the positioning arrangement 110 is the current (or instantaneous) location of the mobile device 202 at substantially the same instant in time as when the variable code 212 is captured. It should be noted, however, that in some situations, the positioning arrangement 110 may be unable to determine the location of the mobile device 202 at the instant when the variable code 212 is captured (e.g., when the mobile device 202 is indoors), in which case, the positioning arrangement 110 may provide the most recently identified location of the mobile device 202 to the client check-in service application for transmission to the server 208. Further, in some implementations, the host check-in service application may reject the check-in when the obtained mobile device location was not identified or otherwise determined substantially contemporaneously to capturing the code value (e.g., when a difference between a time associated with the mobile device location and a time associated with the captured code value exceeds a threshold amount of time).

After obtaining the captured code value and the location of the mobile device 202, the check-in process 300 continues with the host check-in service application by determining a reference code value for the variable code that was presented at the site at the time when the mobile device 202 obtained the captured code value and determining whether the captured code value matches the reference code value for the site (tasks 306, 308). In this regard, the reference code value should be understood as referring to the encoded value that was displayed or otherwise represented by the variable code 212 at the site corresponding to the received site identifier at the instant in time when the mobile device obtained the captured code value. In other words, in the context of FIG. 2, the reference code value is the displayed code value for the variable code 212 that theoretically would have been captured by the mobile device 202 if the mobile device 202 were physically located at the site 204 at the instant in time when the mobile device 202 obtained the captured code value received by the server 208. In an exemplary embodiment, after receiving the site identifier and the captured code value, the host check-in service application on the server 208 determines the reference code value as the displayed code value of the variable code 212 at the time corresponding to the captured code value. In some embodiments where the communications between the mobile device 202 and the server 208 occur substantially in real-time with minimal delay or lag, the server 208 may determine the reference code value as the value of the variable code 212 that is currently being presented at the site 204 matching the received site identifier. In other embodiments, the mobile device 202 may timestamp the captured code value or otherwise provide the time corresponding to the captured code value to the server 208, wherein the server 208 uses the time corresponding to the captured code value and the site identifier to determine the reference code value based on the previously displayed code values for the variable code 212 at the site 204 matching the site identifier. For example, the host check-in service application on the server 208 may utilize the time corresponding to the captured code value to determine which value of a sequence of values was being presented at the site 204 matching the received site identifier at the instant in time when the captured code value was obtained by the mobile device 202.

In an exemplary embodiment, when the check-in process 300 determines that the captured code value does not match the reference code value for the site the user is attempting to check-in at, the check-in process 300 does not validate the mobile device 202 as being at the site the user is attempting to check-in at and exits (task 316). In this regard, the host check-in service application on the server 208 may reject the check-in and cause the mobile device 202 to provide graphical indication of the failed check-in to the user (e.g., by displaying a graphical indication of a failed check-in on the display device 106 within the client check-in service application).

Still referring to FIG. 3, when the check-in process 300 determines that the captured code value matches the reference code value for the site the user is attempting to check-in at, the check-in process 300 continues by obtaining the location associated with the received site identifier, determining whether the received device location corresponds to the site location, and validating the mobile device 202 as being at the site when the device location corresponds to the site location (tasks 310, 312, 314). In an exemplary embodiment, the host check-in service application on the server 208 obtains the stored location associated with the received site identifier corresponding to the site 204. In other embodiments, the site device 206 may maintain the fixed location of the site 204 or include a positioning arrangement configured to identify the location of the site device 206 or the site 204, wherein the host check-in service application may obtain the site location by requesting the location of the site 204 from the site device 206.

After obtaining the location of the site 204, the host check-in service application determines whether the mobile device location corresponds to the site location and validates that the mobile device 202 is at the site 204 when the received device location provided by the mobile device 202 corresponds to the location of the site 204 (task 314). In an exemplary embodiment, the host check-in service application determines that the mobile device location corresponds to the site location when the mobile device location is equal to the site location or the difference between the mobile device location and the obtained site location is less than a threshold distance that indicates that the mobile device 202 is in sufficient proximity to the site 204. In this regard, the mobile device location need not identically match the site location because the captured code value matching the reference code value implicitly indicates that the mobile device 202 is at the site 204. As a result, the check-in is not rejected in situations where the positioning arrangement 110 is unable to determine the location of the mobile device 202 at the instant when the captured code value is obtained (e.g., due to the mobile device 202 being indoors). After validating that the mobile device 202 is at the site 204, the host check-in service application on the server 208 may accept the check-in from the user of the mobile device 202, cause the mobile device 202 to provide graphical indication of the successful check-in (e.g., by displaying a graphical indication of a successful check-in on the display device 106 within the client check-in service application), or take additional actions in response to the successful check-in as desired. In some embodiments, prior to accepting the check-in from the user of the mobile device 202, the host check-in service application may obtain an identifier associated with the mobile device 202 and compare the obtained mobile device identifier to a stored mobile device identifier associated with (or registered with) the user's account to ensure the mobile device 202 matches the mobile device previously associated with the user before accepting the check-in.

It should be noted that by virtue of the encoded value of the variable code 212 dynamically changing over time, and preferably randomly, the check-in process 300 is particularly useful in preventing fraudulent check-ins at the site 204 due to the difficulty in accurately determining the value of the variable code 212 at a particular instant in time without physically observing the variable code 212. Additionally, the check-in process 300 is particularly useful in urban environments where the mobile device location obtained using the positioning arrangement 110 is unreliable either due to a relatively high concentration of sites within a relatively small geographic area or an inability to determine the mobile device location with a desired level of accuracy (e.g., due to buildings and other structures interrupting signals to and from the mobile device 202 used for determining location). At the same time, the obtained mobile device location may be utilized as a safeguard to ensure that the mobile device 202 is physically located at or sufficiently near the site 204 before a check-in is accepted.

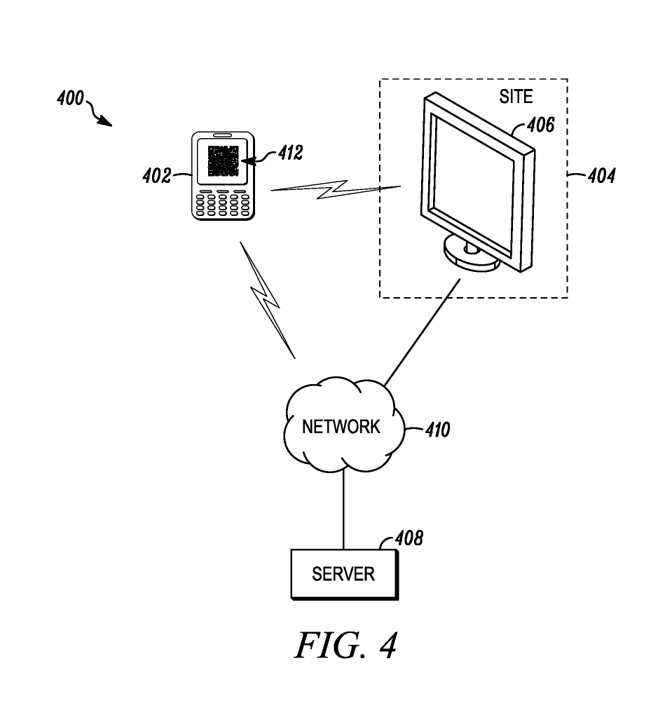

FIG. 4 depicts another exemplary check-in system 400 suitable for implementing the check-in process 300 described above in the context of FIG. 3 to verify that the location of a mobile device 402 (e.g., mobile device 100) is at a site 404. The elements of the check-in system 400 of FIG. 4 are similar to their counterpart elements described above in the context of FIG. 2, and accordingly, the common features and functionality of these elements will not be redundantly described in the context of FIG. 4.

In the illustrated embodiment of FIG. 4, the site device 406 at the site 404 is realized as or otherwise includes a barcode reader, a camera, or another means for capturing and decoding a machine-readable code 412 presented by the mobile device 402. In this regard, the client check-in service application on the mobile device 402 is configured to present or otherwise display a machine-readable code 412, such as a QR code, (e.g., on the display device 106) that is representative of a device identifier and a code value. In an exemplary embodiment, the code value (or encoded value) represented by the code 412 varies, either under control of the client check-in service application or in response to instructions from the host check-in service application. For example, each time the user manipulates the mobile device 402 to check-in to a site, the client check-in service application may update the display device 106 such that the encoded value represented by the code 412 corresponds to a random value. Alternatively, the host check-in service application may periodically instruct the client check-in service application to vary the encoded value represented by the code 412 in a manner similar to that described above.

Referring now to FIG. 3 and FIG. 4, and with reference to FIG. 1, as described above, the check-in process 300 initializes or otherwise begins after a user has manipulated the mobile device 402 to attempt to check-in at the site 404. In this regard, the user of the mobile device 402 manipulates the input device 102 to cause the mobile device 402 to execute a client check-in service application that communicates with the host check-in service application being executed by the server 408 via the network 410. Upon execution, the client check-in service application or the host check-in service application updates the code 412 displayed by the mobile device 402 such that the encoded value represented by the code 412 is a random value. The user of the mobile device 402 then positions the mobile device 402 with respect to the site device 406, wherein the barcode reader of the site device 406 captures, scans, decodes, or otherwise obtains the encoded value of the code 412 at that particular instant in time along with the device identifier for the mobile device 402 included in the code 412.

In an exemplary embodiment, after obtaining a captured code value for the code 412, the site device 406 transmits the captured code value, the captured device identifier, and the site identifier associated with the site 404 to the host check-in service application on the server 408. After receiving this information from the site device 406 (task 304), the host check-in service application utilizes the device identifier to contact the client check-in service application on the mobile device 402 and to obtain the location of the mobile device 402 (e.g., the location provided by positioning arrangement 110) (task 302). Additionally, the host check-in service application determines the reference code value for the code 412 at the time corresponding to the captured code value (task 306). In some embodiments, the host check-in service application determines the reference code value by contacting the client check-in service application and obtaining the random value for the code 412 that was presented by the mobile device 402 at the time corresponding to the captured code value. In this regard, the reference code value may be the encoded value currently being represented or otherwise displayed by code 412 on the mobile device 402. In other embodiments, the host check-in service application may determine the reference code value for the code 412 as the random value the host check-in service application instructed the client check-in service application to display on the mobile device 402.

After determining the reference code value for the code 412, the check-in process 300 continues with the host check-in service application determining whether the captured code value received from the site 404 matches the reference code value for the code 412 presented by the mobile device 402 (task 308). When the captured code value matches the reference code value, the host check-in service application continues by obtaining the location of the site 404, determining whether the location of the mobile device 402 corresponds to the site location, and validating the mobile device 402 as being at the site 404 when the device location corresponds to the site location, in a manner similar to that set forth above (tasks 310, 312, 314). Thus, the presence of the mobile device 402 at the site 404 may be verified or otherwise validated, and after validating that the mobile device 402 is at the site 404, the host check-in service application on the server 408 may accept the check-in from the user of the mobile device 402 and take additional actions as desired.

It should be noted that although the subject matter is described herein in the context of machine-readable codes, other technologies may be utilized to securely exchange the code values between the site and the mobile device. For example, near-field communication, radio-frequency identification, or the like may be utilized to establish a secure communications channel between the mobile device and the site that is utilized by either the mobile device or the site to obtain a current value for a variable code at an instant in time (i.e., a captured code value) that is subsequently compared to a reference value for the variable code at that instant in time to verify the mobile device's location as being at the site, as described above.

While at least one example embodiment has been presented in the foregoing detailed description, it should be appreciated that a vast number of variations exist. It should also be appreciated that the example embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

We claim:

1. A method of verifying that a device is at a site, the method comprising:
obtaining, from the device, a location of the device;
obtaining a captured value for a code from one of the device and the site, the code being presented by the other of the device and the site; and
when the captured value is equal to a reference value for the code, verifying that the device is at the site when the location of the device corresponds to a location associated with the site.

2. The method of claim 1 wherein the reference value is a random value represented by the code at an instant in time corresponding to the captured value.

3. The method of claim 1:
wherein the code is representative of a code value that varies; and
wherein the reference value corresponds to the code value at a time corresponding to the captured value.

4. The method of claim 1:
wherein the code is presented by the site; and
wherein obtaining the captured value comprises receiving the captured value from the device, the captured value corresponding to a decoded value of the code that was captured by the device.

5. The method of claim 4 further comprising:
determining the reference value as a current value represented by the code in response to receiving the captured value.

6. The method of claim 1:
wherein the code is variable; and
wherein the method further comprises determining the reference value as an encoded value represented by the code at a time corresponding to the captured value.

7. The method of claim 6:
wherein the site is configured to vary the encoded value in accordance with a sequence of values; and
wherein the reference value is determined based on the sequence of values and the time corresponding to the captured value.

8. The method of claim 7:
wherein the captured value is captured at a first time; and
wherein determining the reference value comprises determining a value of the sequence of values represented by the code at the first time.

9. The method of claim 1:
wherein the code is presented by the device;
wherein obtaining the captured value comprises receiving the captured value from the site, the captured value corresponding to a decoded value of the code that was captured by the site.

10. The method of claim 9 wherein obtaining the reference value comprises obtaining a random value from the device, the code being representative of the random value.

11. The method of claim 9:
wherein the captured value is captured at a first time; and
wherein the method further comprises receiving, from the device, an encoded value for the code at the first time, the reference value being equal to the encoded value.

12. The method of claim 1:
wherein the code comprises a quick response code including a site identifier corresponding to the site and a variable code value, the reference value corresponding to the variable code value at a time corresponding to the captured value; and
wherein the method further comprises obtaining a site location associated with the site identifier, the device being verified as at the site when the location of the device corresponds to the site location.

13. A method of validating that a device is at a site, the method comprising:
receiving, from the device, a device location;
receiving, from the device, a captured value for a machine-readable code presented by a site device at the site;
determining a reference value for the machine-readable code, the reference value corresponding to an encoded value represented by the machine-readable code at a time corresponding to the captured value, wherein the encoded value is variable; and
when the captured value matches the reference value:
obtaining a site location for the site; and
validating the device as being at the site when the device location corresponds to the site location.

14. The method of claim 13 wherein determining the reference value comprises determining the encoded value currently being presented by the site device in response to receiving the captured value.

15. The method of claim 13 further comprising:
receiving, from the device, a site identifier associated with the captured value, wherein obtaining the site location comprises obtaining a location associated with the site identifier in response to determining that the captured value matches the reference value.

16. The method of claim 13 wherein the machine-readable code comprises a quick response (QR) code.

17. The method of claim 16 wherein the QR code includes the encoded value and a site identifier associated with the site.

18. The method of claim 17 further comprising:
receiving the site identifier from the device, wherein obtaining the site location comprises obtaining a location associated with the site identifier in response to determining that the captured value matches the reference value.

19. A server comprising a control module and a memory, wherein the memory comprises computer-executable instructions that, when executed by the control module, cause the server to:
obtain a reference value for a code in response to receiving a captured value for the code, the captured value corresponding to a decoded value of the code at a first time received from one of a mobile device and a site device at a site, wherein the reference value corresponds to an encoded value represented by the code presented by the other of the mobile device and the site device at the first time;
determine whether the captured value matches the reference value; and
in response to determining that the captured value matches the reference value, verify that the mobile device is at the site when a current location of the mobile device matches a location associated with the site.

20. The server of claim 19:
wherein the captured value is received from the mobile device; and
wherein the computer-executable instructions cause the server to determine the encoded value represented by the code presented by the site device at the first time.
